(19) United States
(12) Patent Application Publication
(10) Pub. No.: US 2011/0244883 A1
(43) Pub. Date: Oct. 6, 2011

(54) METHOD AND MOBILE RADIO TERMINAL DEVICE TO DETERMINE POSITION WITHIN MOBILE RADIO NETWORKS BY MEANS OF DIRECTION FINDING

(76) Inventor: Michael Quade, Bonn (DE)

(21) Appl. No.: 13/121,197

(22) PCT Filed: Feb. 25, 2010
(86) PCT No.: PCT/EP10/01201

§ 371 Date: Jun. 21, 2011

(30) Foreign Application Priority Data
Mar. 3, 2009 (DE) 102009017426.5

(51) Int. Cl. H04W 24/00

(52) U.S. Cl. 455/456.1

(57) ABSTRACT

The invention relates to a method for determining the position of a mobile radio terminal device (13, 22) within a cellular mobile radio network, wherein the mobile radio network has a plurality of cells, each comprising a base station (12, 14, 21), wherein the terminal device (13, 22) is logged in one or more base stations (12, 14, 21), wherein the position determination is effected by the terminal device (13, 22) by a direction-finding action to locate at least one base station (12, 14, 21), the absolute position of which is known, wherein the direction-finding is effected by a directional antenna integrated into the terminal device (13, 22) by directing the main lobe of the directional antenna towards the location of the base station (12, 14, 21).

The invention relates to a method and a mobile radio terminal device to determine the position of a mobile radio terminal device within a cellular radio network, wherein the mobile radio network has a plurality of cells, each having a base station, wherein the terminal device is logged or can be logged in one or more base stations.

The location of mobile communication terminal devices in mobile radio communication networks is currently performed cell-based by using the position of the respective base station into which the terminal device is logged in since the base station covers a defined region. The disadvantageous aspect here is that only the region is known—not the exact position of the mobile radio terminal device within this quite large region.

In addition, an approach is known whereby propagation time measurements of the electromagnetic signals coming from multiple base stations are evaluated to improve the positional accuracy, wherein a more precise position determination can then be performed by triangulation.

What is disadvantageous here is that the terminal device must be logged in at least three base stations simultaneously and that the triangulation measurement is quite laborious.

Another disadvantage of the known method for position determination is that the accuracy is quite limited. A further desirable goal for multiple applications is that a position determination should be able to be performed by the terminal device—something that is not possible using the known methods.

The purpose of the invention is to provide a method and a mobile radio terminal device for determining the position of the mobile radio terminal device within a cellular mobile radio network, the method providing a highly accurate determination of the position of the mobile radio terminal device within the cellular mobile radio network.

This purpose is achieved according to the invention by a method indicated in claim 1, and by a mobile radio terminal device indicated in claim 6. Advantageous developments of the invention are indicated in the respective dependent claims.

What is especially advantageous about the method for determining the position of a mobile radio terminal device within a cellular mobile radio network, wherein the mobile radio network has a plurality of cells, each having a base station, wherein the terminal device is logged in one or more base stations, is the fact that the position determination by means of the terminal device is performed by direction finding locating at least one base station, the position of which is known, wherein the direction finding is performed by a directional antenna integrated into the terminal device by directing the main lobe of the directional antenna toward the location of the base station.

Determining the position of the mobile radio terminal device is thus performed by direction finding to locate at least one base station in which the mobile radio terminal device is logged. Here the absolute position of the base station located by direction finding is known. This method is well-known by the term beam-forming. The associated antenna systems are often called smart antennas.

In particular, a so-called MIMO antenna can be used as the directional antenna. In telecommunications engineering, MIMO (Multiple-Input Multiple-Output) stands for the use of multiple transmitting and receiving antennas for wireless communication.

Preferably, direction findings of two or more base stations are performed by the terminal device, and the intersection of these directions is determined so that the location of the terminal device within the mobile radio network is determined, too.

Alternatively or cumulatively, when performing one or more direction-finding actions, the individual propagation time of the radio signal between a base station and the terminal device can be measured, wherein the distance between base station and terminal device is determinable/is determined from the propagation time measurement.

In a preferred embodiment, the absolute location of each one of the base stations located by direction finding by the terminal device is transmitted to the terminal device for analysis. This can be performed either directly by the base station to the terminal device and/or by requesting a database search. In particular, it is possible to integrate such a database in the mobile radio terminal device so that the absolute location of each base station located by direction finding is known, with the result that the absolute location of the terminal device is determinable from this absolute location of the base station and the location of the mobile radio terminal device relative to the base station.

The direction of the direction finding is preferably calibrated for a standard direction. This standard direction can be the orientation of the mobile radio terminal device itself, or, on the other hand, a cardinal point, in particular, north N.

An especially advantageous aspect of the mobile radio terminal device according to the invention, which can be logged in one or more base stations within a cellular mobile radio network that has a plurality of cells each of which comprising one base station, is the fact that the mobile radio terminal device has a directional antenna to determine position and is equipped to perform one or more direction-finding actions by directing the main lobe of the directional antenna toward one or more base stations, the absolute position(s) of which is/are known and in which the terminal device is logged.

Here, a so-called MIMO antenna can be used as a directional antenna. In telecommunications engineering, MIMO (Multiple-Input Multiple-Output) stands for the use of multiple transmitting and receiving antennas for wireless communication.

The mobile radio terminal device is preferably equipped for the purpose of measuring the propagation time for the radio signal between the mobile radio terminal device and a base station, from which time the distance between terminal device and base station is determinable/is determined.

In a preferred embodiment, the mobile radio terminal device comprises a compass and is equipped to calibrate the direction of the direction finding relative to a standard direction, especially to a cardinal point, in particular, the angle, i.e. the deviation from north N. This action thus determines the angle of orientation of the direction finding toward the base station.

In an especially preferred embodiment, the mobile radio terminal device has a database in which the absolute positions of the base stations are stored, with the result that the absolute location of a base station located by direction finding is requestable in the database and is available in the mobile radio terminal device for further evaluation. Alternatively or cumulatively, the mobile radio terminal device can be equipped to automatically perform this database request in an external database. Preferably, the data requested from the database are further processed automatically.

This position determination can, for example, be used to determine and automatically transmit the current position of the mobile radio terminal device within the cellular mobile radio network in the case of an emergency call or the like. Additional possible uses are: navigation, location based services, tracking applications, as well as other telematic applications that require a locating functionality.

In the method according to the invention, the mobile radio terminal device thus preferably utilizes a database in which the transmitted identifiers of mobile radio cells, such as, e.g. the cell identity (Cell-ID), are assigned to geographic positions. The database can be integrated into the terminal device, or provided by an external device, e.g. by a server that allows a database search by the mobile radio terminal device.

In addition, the relative angle of the main direction of the main lobe (radio beam) to a base station that is located by direction finding is determined by the radio equipment employed. A direction finding measurement of base stations is enabled by the fact that a directional antenna, in particular, MIMO antennas, are used in which the radio lobe can be adjusted individually toward the given base station by phase shifting the individual antennas of the directional antenna. This method can be employed when a TDD mode (Time Division Duplex) is used, as the communication is then executed in each time interval with only one mobile communication terminal device in one mobile communication cell. Possible mobile radio standards to achieve this are, in particular: GSM (including GPRS, EDGE), UMTS in the TDD mode (including HSxPA), WiMAX, Long Term Evolution (LTE), High Speed OFDM Packet Access (HSOPA), or other mobile radio standards that permit the use of MIMO antennas.

In a special embodiment, an electronic compass is integrated in the terminal device, thereby allowing the measured relative angles of the main direction of the main lobe to be determined as absolute angles, e.g. in relation to north N.

In addition, the signal propagation time of a signal transmitted by the base station to the terminal device can mathematically be converted to a distance by setting the signal propagation speed as being approximately the speed of light.

What may happen, however, is that the direction finding result is distorted by the signals' being reflected from surfaces, such as, e.g. the sides of buildings, and that the correct angles can no longer be determined. Therefore, the method of this invention can in particular be used outside urban regions, for example, for navigation solutions on highways and the like. In addition, accuracy can be enhanced by using multiple base stations that utilize a frequency as high as possible. This increases the probability of a direct “line-of-sight connection” without reflections between terminal device and base station.

An evaluation of the direction-finding action now yields a variety of applications, either alone or in combination, that are described below based on the two figures.

The figures show:

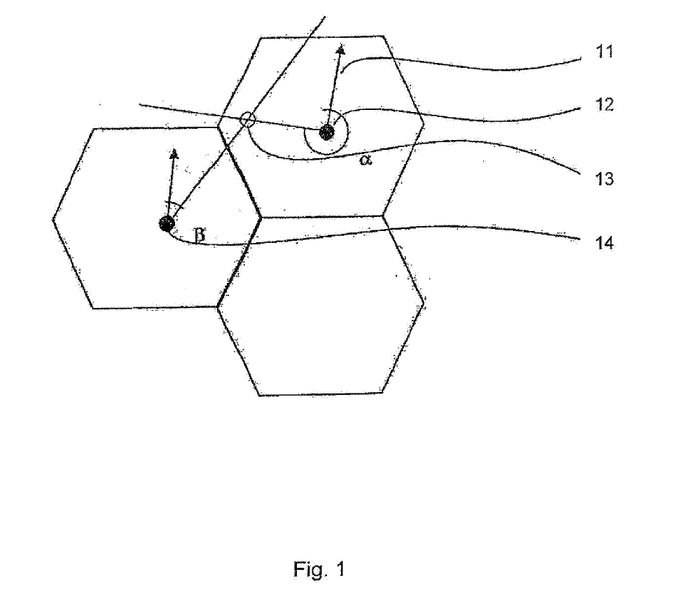

FIG. 1 illustrates a first application for position determination by locating two base stations by direction finding;

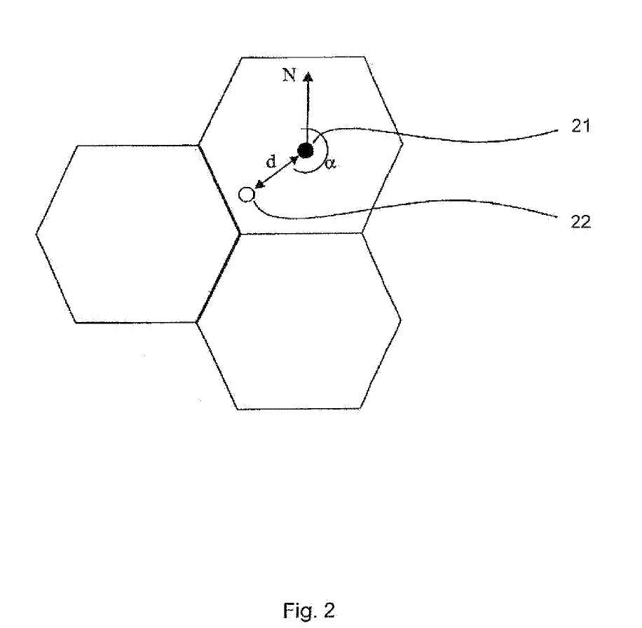

FIG. 2 illustrates a second application for position determination by locating a base station by direction finding and measuring the signal propagation time.

In one embodiment illustrated in FIG. 1, the two relative angles a and β are determined in relation to the orientation 11 of the terminal device. For this, both reachable base stations 12 and 14, i.e. those base stations lying within radio range, are located by direction finding from the location 13 of the terminal device. The two angles a and β thereby determined, starting from location 13 relative to base stations 12 and 14, are then referenced in relation to the orientation 11 of the terminal device itself.

By evaluating a geodatabase that contains the positions of base stations 12 and 14, it is now possible to determine the intersection 13 of the at least two bearings (directions of direction-finding). Intersection 13 of the two bearings with respect to base stations 12 and 14 thus represents the position of the terminal device.

Since the absolute positions of base stations 12 and 14 are known from the geodatabase, it is also possible not only to determine the relative positioning of intersection 13 in relation to the position of base stations 12 and 14, but also absolute location 13.

In a second embodiment illustrated in FIG. 2, only one base station 21 is required to determine the position of terminal device 22. The distance d between location 22 of the mobile radio terminal device and the location of base station 21 is determined using the signal propagation time measured between base station 21 and terminal device 22. !n addition, a normalized angle a is determined from the measured bearing and the compass direction in relation to the north direction N. As a result, position 22 relative to the position of base station 21 can now be calculated—from angle a in relation to north N and distance d. The absolute position of terminal device 22 can be determined based on the geodatabase from which the absolute position of base station 21 is requestable.

In addition, the possibility exists of combining the two embodiments so as to enhance the accuracy of the position determination by the combined location by direction finding of multiple base stations and propagation time measurement.

An approach is thus provided according to the invention whereby the given direction of the radio beam, i.e. the main lobe of the directional antenna, from the terminal device to the base station is used to determine the position of terminal devices in mobile radio networks by means of direction finding using directional antennas, for example, MIMO antennas, in which the mobile radio networks use the TDD mode (time-division-duplex). In order to determine the absolute position of the mobile radio terminal device, the system can exploit a geodatabase from which the absolute position of the base station located by direction finding is searchable, with the result that the absolute position of the mobile radio terminal device can be derived from the bearing (direction of direction-finding) and the determination of the relative position in relation to the base station.

In addition, a propagation time measurement can be performed to determine the distance between mobile radio terminal device and base station located by direction finding. An electronic compass can also be integrated in the mobile radio terminal device, thus allowing a geodatabase, a bearing, the measured signal propagation time, and an electronic compass to be used to effect the geographic position determination.

In addition, the possibility exists of further processing the data of the position determination in an application within the terminal device, for example, generating an automatic communication when initiating an emergency call containing the determined position of the mobile radio terminal device.

The geodatabase containing the absolute positions of the base stations can be integrated in the terminal device. An identification and assignment of the base stations can, for example, be performed by using the cell identity.

Alternatively, the possibility also exists whereby the geodatabase is disposed externally, i.e. is situated on another device, and the terminal device can retrieve information from the database, then further evaluate/exploit this information.

1-9. (canceled)

10. A method of determining the position of a mobile radio terminal device within a cellular mobile radio network that has a plurality of cells each provided with a respective base station, the method comprising the steps of:
logging the terminal device into one or more of the base stations;
effecting position determination by the terminal device by a direction-finding action to locate at least one base station whose absolute position is known; and
effecting the direction finding by a directional antenna integrated into the terminal device by
directing the main lobe of the directional antenna toward the location of the base station whose position is known,
measuring the propagation time for the radio signal between the base station whose position is known and the terminal device, and
from this propagation time, determining the distance between the base station and terminal device.

11. The method according to claim 10, wherein the direction-finding actions locating two or more base stations are performed by the terminal device, and the intersection of these directions found by direction-finding actions is determined.

12. The method according to claim 10, wherein the absolute position of each base station located by direction finding by the terminal device is transmitted for analysis to the terminal device, in particular, that the absolute position is provided directly by the base station to the terminal device or provided by a database in response to a database request.

13. The method according to claim 10, wherein the direction of the direction-finding is calibrated relative to a standard direction, in particular, relative to a direction of the compass, in particular, that the angle in relation to north is determined.

14. A mobile radio terminal device that can be logged in one or more base stations within a cellular mobile radio system that has a plurality of cells, each having one base station, in particular, for using and implementing the method according to claim 10, wherein the mobile radio terminal device has a directional antenna for determining its position, the terminal device being equipped to perform one or more direction-finding action/s by directing the main lobe of the directional antenna toward one or more base stations, the absolute position of which is/are known and in which/into which the terminal device is logged, and that the mobile radio terminal device is equipped to measure the propagation time of a radio signal between the mobile radio terminal device and a base station and to determine from this propagation time the distance between terminal device and base station.

15. The mobile radio terminal device according to claim 14, wherein the mobile radio terminal device has a compass and is equipped to calibrate the direction of the direction-finding relative to a standard direction, in particular relative to a direction of the compass, in particular in relation to north.

16. The mobile radio terminal device according to claim 14, wherein the mobile radio terminal device has a database, wherein the absolute location of a base station located by direction finding is requestable through a database search.
